(19) United States
(12) Patent Application Publication
(10) Pub. No.: US 2024/0190767 A1
(43) Pub. Date: Jun. 13, 2024

(54) METHOD FOR RECYCLING CEMENT-CONTAINING MATERIALS TO PRODUCE RECLAIMED FINES FOR USE IN CEMENT-BASED MATERIALS AND STRUCTURES

(71) Applicant: Rowan University, Glassboro, NJ (US)

(72) Inventors: Shahriar Abubakri, Glassboro, NJ (US); Gilson R. Lomboy, Williamstown, NJ (US); Islam M. Mantawy, Glassboro, NJ (US)

(21) Appl. No.: 18/524,709

(22) Filed: Nov. 30, 2023

Related U.S. Application Data
(60) Provisional application No. 63/431,193, filed on Dec. 8, 2022.
(60) Provisional application No. 63/521,229, filed on Jun. 15, 2023.

(51) Int. Cl. C04B 18/167; C04B 14/06; C04B 26/26

(52) U.S. Cl. CPC C04B 18/167; C04B 14/06; C04B 26/26

(57) ABSTRACT

An environmentally-friendly substitute for virgin dry cement is provided. The substitute is obtained as reclaimed cementitious fines produced by recycling cement-containing waste materials, such as recycled concrete aggregate and demolished brick structures. The reclaimed cementitious fines are used as cementitious material in new concrete, mortar, cement paste and other cement-containing materials and structures. A recycling method involves obtaining cement-containing waste material, crushing the cement-containing waste material, gathering the crushed cement-containing waste materials, the crushed cement-containing waste materials comprising reclaimed particles derived from said cement-containing waste material; and sorting the crushed cement-containing waste materials by particle size to obtain reclaimed cementitious fines having sizes in a desired particle size range, e.g., 0.1 micron to 200 micron for use as a substitute for virgin dry cement powder. Notably, the crushing/tumbling methodologies used to obtain the reclaimed particles produce significantly less carbon dioxide that the methodologies used to obtain virgin dry cement.

### CROSS-REFERENCE TO RELATED APPLICATIONS

This application claims the benefit of priority, under 35 U.S.C. § 119(e), of U.S. Provisional Patent Application No. 63/431,193, filed Dec. 8, 2022, and U.S. Provisional Patent Application No. 63/521,229, filed Jun. 15, 2023, the entire disclosure of each of which is hereby incorporated herein by reference.

### FIELD OF THE INVENTION

The present invention relates generally to concrete, mortar, and other cement-containing materials, and more particularly, to a method for recycling cement-containing materials to produce reclaimed fine particles suitable for use as cementitious material in new concrete, mortar and other cement-containing materials and structures.

### DISCUSSION OF RELATED ART

Cement material is generally used in a fine, soft powder form. It is generally produced from a mixture of limestone and clay, and is suable as a binder material because it hardens after contact with water.

Cement material (e.g., Portland cement) is widely used in the construction of buildings, bridges, roadways, sewers and drainage conducts, structural and ornamental objects and other items (collectively “structures”). With respect to building materials, cement is used as a component of concrete, which is made by mixing fine cement material, fine to coarse aggregate material, and water. Cement is also used as a component of mortar, which is often a mixture of sand, cement, lime and water that can be used between bricks, cinder blocks, etc. in the building of brick or block walls. Cement is also used in asphalt as binder. Accordingly, cement-containing materials include concrete, mortar, and structures made of concrete and/or mortar.

Virgin (new) cement is typically manufactured by burning limestone, which makes a significant amount of carbon dioxide (CO₂), which has a significant undesirable “greenhouse gas” effect that is environmentally unfriendly. Accordingly, the manufacture of new cement, and therefore structures including new cement, produce carbon dioxide, which is undesirable.

Additionally, slag and fly ash resulting as byproduct from combustion processes of the coal and iron industries (which also produce carbon dioxide) are sometimes used as supplementary cementitious materials that are mixed into new concrete. The combustion processes associated with the production of iron and coals and their byproducts such as slag and fly ash make a significant amount of carbon dioxide, which has a significant undesirable “greenhouse gas” effect that is environmentally unfriendly. Accordingly, the manufacture of concrete including such cementitious materials, and structures including such concrete, produce carbon dioxide, which is also undesirable.

Concrete and other cement-containing materials and structures are often demolished by hazards such as earthquakes, missiles, bombs, for various other reasons, and often end up in landfills. Demolished cement-containing structures are often replaced with new cement-containing structures, requiring new cement material, which leads to more substantial carbon dioxide emissions. Even in instances in which new structures are not replacing old structures, continued demand for cement and cement-based building materials will continue to contribute to substantial carbon dioxide production and environmental emissions.

What is needed a method for cement production that does not require significant carbon dioxide production and emissions.

### SUMMARY

The present invention relates generally to recycling cement-containing materials to produce reclaimed fine particles suitable for use as cementitious material in new concrete, mortar, cement paste and other cement-containing materials and structures. Due to the wide availability of demolished cement-containing materials (e.g., concrete), and to the environmentally friendly recycling method described herein, an environmentally-friendly cement material substitute can be obtained and used without the significant carbon dioxide production and emissions associated with the production of virgin cement, virgin concrete and/or other cement-containing materials containing virgin cement.

Accordingly, the present invention can be used to reduce the demand for new cement (e.g., for use in concrete, mortar, cement paste and/or asphalt), by using reclaimed cementitious fine particles “fines” that may be heterogeneous, depending upon the composition of the original cement-containing materials, and may be composed entirely, or only partially, of previously-used cement material, and yet are suitable for use as cementitious fine particles in substitution for virgin dry cement powder material to produce satisfactory cement-containing materials (such as cement paste, concrete, mortar, and structures including concrete and/or mortar). The reclaimed cementitious fines are used, in accordance with the present invention, in substitution for virgin cement powder, e.g., to produce new cement-containing materials such as concrete, mortar, cement paste and asphalt that includes reclaimed cementitious fines, e.g., as at least a partial replacement for virgin cement. Accordingly, the reclaimed cementitious fines produced according to this method can be used to produce a relatively more environmentally-friendly concrete by at least partial substitution of virgin cement material with reclaimed cementitious fines.

### BRIEF DESCRIPTION OF THE FIGURES

An understanding of the following description will be facilitated by reference to the attached drawings, in which:

FIGS. 1A and 1B illustrate a process of recycling concrete to make reclaimed cementitious fines in accordance with the present invention;

FIG. 2A shows obtained cement-containing waste materials (e.g., recycled concrete aggregates) in random sizes, ready for crushing by tumbling with heavy steel balls, grinding, and abrasion (e.g., in a drum of an LA abrasion machine);

FIG. 2B shows the obtained cement-containing waste materials of FIG. 2A, with heavy steel balls added to the drum prior to crushing;

FIG. 2C shows the crushed RCA, including reclaimed cementitious fine particles produced by crushing, along with the heavy steel balls;

FIG. 2D shows the crushed RCA, including reclaimed cementitious fine particles produced by crushing, after removal of the heavy steel balls, and prior to sorting/sieving to obtain cementitious fines with desired particle sizes;

FIG. 3 shows a table of chemical compositions of exemplary recycled cements in accordance with the present invention in comparison to Portland cement;

FIG. 4 shows a table of exemplary cement paste and mortar specimens prepared with OPC Type I, incorporating varying proportions of reclaimed cementitious fine parties (RC) (percentage by weight of binder);

FIG. 5 shows a graph of compressive strength of cement paste specimens with different percentages of reclaimed cement in accordance with the present invention;

FIG. 6 shows a graph of compressive strength of mortar specimens with difference percentages of reclaimed cement in accordance with the present invention;

FIG. 7 shows a table comparing flow measurements for the cement paste and mortar specimens shown in FIG. 4;

FIG. 8 shows a graph comparing final setting times for the cement paste and mortar specimens shown in FIG. 4;

FIG. 9 shows a graph of total heat rate of hydration for the cement paste specimens shown in FIG. 4; and

FIG. 10 shows a graph of accumulative head of hydration for the cement paste specimens shown in FIG. 4.

### DETAILED DESCRIPTION

The present invention provides a method for recycling cement-containing materials to produce reclaimed cementitious fines (fine particles) suitable for use as cementitious material in new concrete, mortar, cement paste and other cement-containing materials and structures. More particularly, the present invention provides a method for producing reclaimed cementitious fines from demolished concrete or other cement-containing materials, e.g., such as those that have been previously used in structures that have been destroyed or disassembled, and would otherwise be handled as waste.

In accordance with the present invention, the method comprises obtaining cement-containing waste materials (such as recycled concrete aggregate (RCA), demolished concrete aggregates, demolished brick or block walls containing cement-based mortar, etc.), crushing the cement-containing waste materials to form reclaimed particles, at least some of those particles being finely-sized particles having any combination of sizes within the range of about 0.1 microns to about 200 microns. Generally, virgin dry cement material particles used in cement-containing materials has a particle size of approximately 15 microns. It is believed that a smaller particle size is generally preferred, and that particle sizes smaller than 100 microns is most preferred.

By way of example, the crushing may involve one or more crushing steps, and each crushing step may involve tumbling, abrasion, grinding and/or impact-based steps. By way of example, a crushing step involving tumbling of cementitious waste materials in a drum along with heavy steel balls heavy and hard enough to crush the cementitious waste materials during tumbling in the drum (in a manner somewhat similar to a conventional Los Angeles (LA) testing process) may be suitable for this purpose.

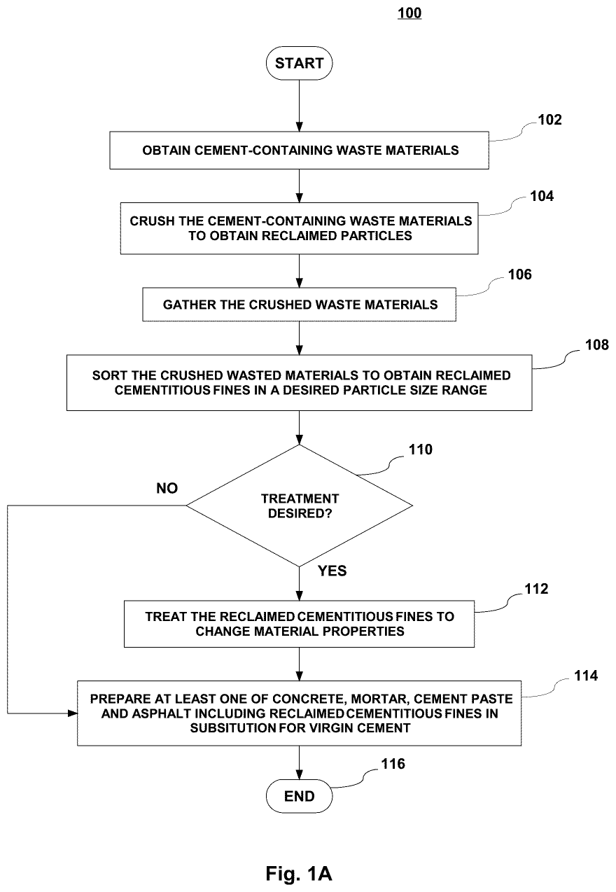

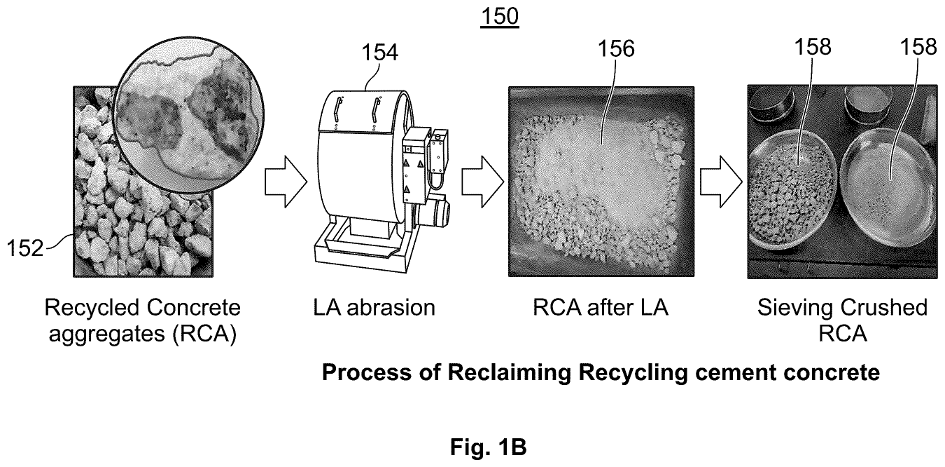

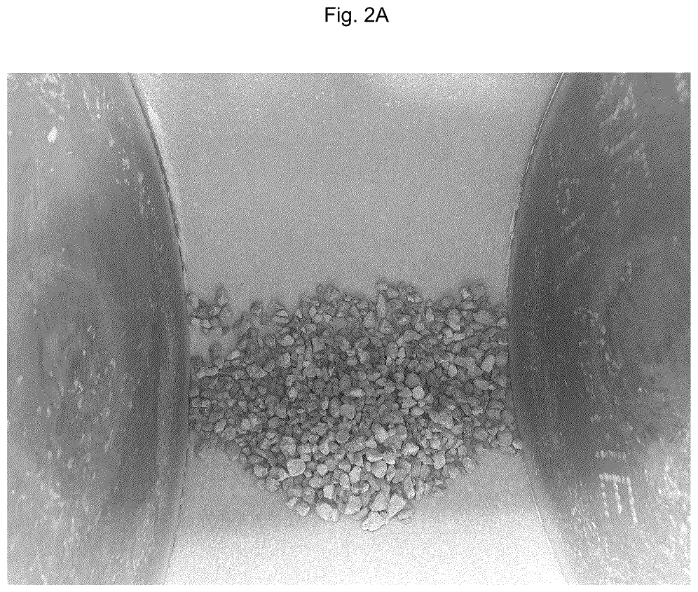

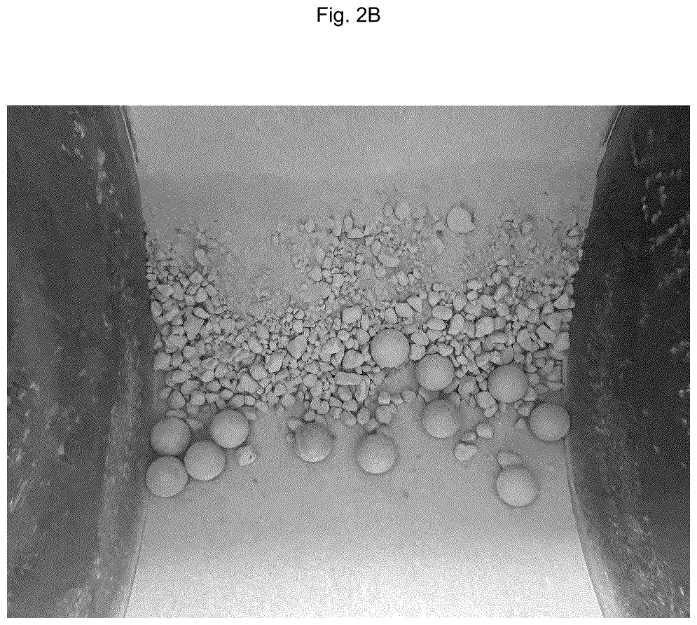

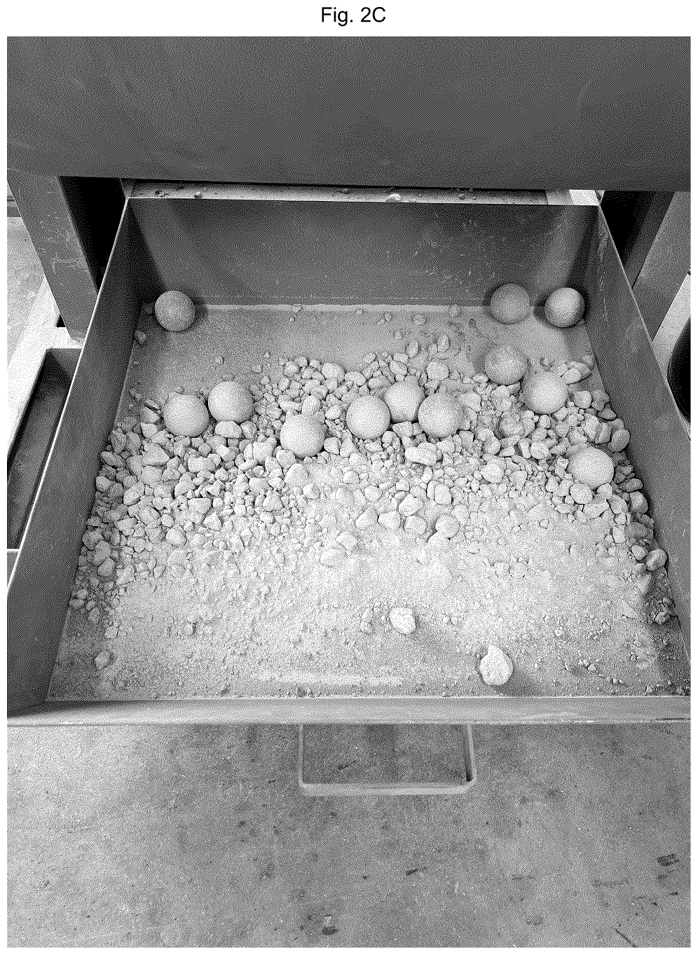

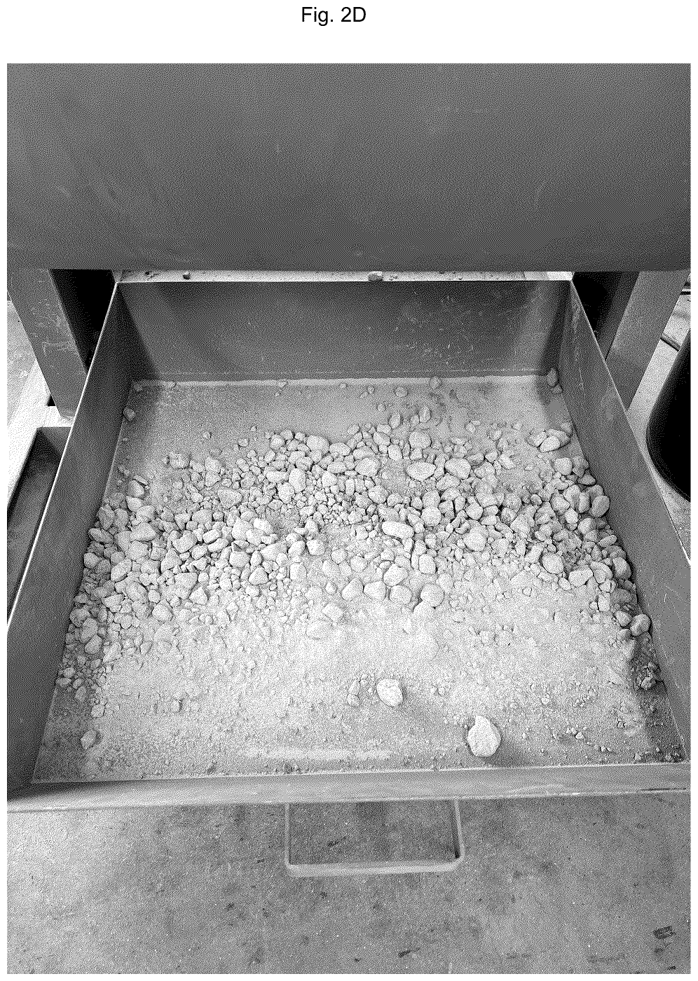

FIG. 1A is a schematic diagram illustrating an exemplary method for recycling concrete to produce reclaimed cementitious fines in accordance with an exemplary embodiment of the present invention. As shown in FIG. 1A, the exemplary flow diagram 100 starts with obtaining cement-containing waste materials (such as recycled concrete aggregate (RCA), demolished concrete aggregates, demolished brick or block walls containing cement-based mortar, etc.), as shown at 102. RCA is shown in image 152 of schematic flow diagram 150 of FIG. 1B. RCA is also shown in FIGS. 2A and 2B.

Referring again to FIG. 1A, the exemplary method next involves crushing the cement-containing waste materials, as shown at 104. By way of example, the crushing may involve one or more crushing steps, and each crushing step may involve tumbling, abrasion, grinding and/or impact-based steps. By way of example, a crushing step involving tumbling of cementitious waste materials in a drum along with heavy steel balls heavy and hard enough to crush the cementitious waste materials during tumbling in the drum may be suitable for this purpose. This may be performed in a manner somewhat similar to use of a conventional Los Angeles (LA) testing process in an LA abrasion machine. An exemplary LA abrasion machine 154 (drum-based tumbling machine) is shown in FIG. 1B. Crushed materials from crushing in the drum of machine 154 are shown in FIGS. 2C and 2D.

The method next involves gathering the crushed waste materials, as shown at 106. By way of example, at least some of those reclaimed particles may be finely-sized particles having any combination of sizes within the range of about 0.1 microns to about 200 microns. Generally, virgin dry cement material particles used in cement-containing materials has a particle size of approximately 15 microns. It is believed that a smaller particle size is generally preferred, and that particle sizes smaller than 100 microns is most preferred. Exemplary crushed waste materials are shown at 156 in FIG. 1B, and in FIGS. 2B and 2C.

Optionally, the method may next involve sorting crushed waste materials by particle size, as shown at 108. Such sorting may comprise separating reclaimed fines from the reclaimed particles to provide reclaimed cementitious fines, the reclaimed particles being finely-sized particles having sizes in the range of about 0.1 microns to about 200 microns. By way of example, separating the reclaimed fines from the reclaimed particles may involve sieving the reclaimed parties to obtain reclaimed cementitious fines with any desired particle size, average particle size, or particle size distribution. The desired particle size and/or distribution may vary according to each desired end-use application. Sorted crushed waste materials are shown as separated into coarse particles and fine particles at 158 in FIG. 1B. For example, this may involve separating the fine particles from the coarse particles shown in FIGS. 2B and 2C.

Optionally, the method may further comprise treating the reclaimed cementitious fines to form usable reclaimed cementitious fines have material properties changed from the original material properties of the crushed waste materials. By way of example, such treatments may involve one or more steps as desired, such as heating, burning, adding additives, adding fillers, adding pigments, etc.

If treatment is desired, then the reclaimed cementitious fines may be treated to change the material properties as desired, as shown at 110 and 112. Method flow continues then continues to 114. If treatment is not desired at 110, then flow may continue directly to 114.

Then, in accordance with one exemplary application, the reclaimed cementitious fines (e.g., treated or untreated reclaimed cementitious fines) resulting from the previous steps may then be used to prepare at least one of concrete, mortar, cement paste and asphalt that includes such reclaimed cementitious fines in at least partial substitution for virgin cement material, as shown at 114, and the method ends, as shown at 116.

Creating reclaimed cementitious fines in this manner requires significantly less carbon dioxide production as compared with processes for creating virgin dry cement powder material. Accordingly, use of such reclaimed cementitious fines reduces the overall carbon dioxide production associated with the concrete, masonry and asphalt industries by reducing the amount of carbon dioxide-intensive virgin cement material required to be produced for given concrete, masonry and asphalt needs, in a carbon-dioxide-efficient manner.

The particle size/average particle size/size distribution and quantity of the reclaimed cementitious fines that is incorporated into new concrete in substitution for virgin cement material can be varied as desired to achieve desired structural properties of the cured concrete, such as mechanical (e.g., compressive strength, flexural strength, tensile strength, bond strength, bond to reinforcement, etc.) and durability (e.g., porosity, electric resistivity, creep, shrinkage, resistance to freeze and thaw, resistance to carbonation, etc.). In certain applications, up to 80%, up to 75%, up to 70%, up to 65%, up to 60%, up to 55%, up to 50%, up to 45%, up to 40%, up to 35%, up to 30%, up to 25%, up to 20%, up to 15%, up to 10% and up to 5% of virgin cement material may be substituted with reclaimed cementitious fines produced according to the present invention to obtain cement-based materials having satisfactory material properties.

In accordance with another exemplary application, reclaimed particles and/or reclaimed cementitious fines (e.g., usable reclaimed cementitious fines) resulting from the crushing step may be used as supplementary cementitious materials, e.g., as materials for producing concrete or asphalt. By way of example, reclaimed particles having a relative coarse particle size (e.g., greater than those of the reclaimed cementitious fines) may be suitable for use as supplementary cementitious materials in a concrete aggregate, e.g., to replace supplementary cementitious materials obtained by a conventional process that produces a higher-level of carbon dioxide.

Creating fine reclaimed particles in this manner also requires significantly less carbon dioxide production as compared with processes for creating iron and coal and their byproduct slag/fly ash or other supplementary cementitious materials for mixing into new/virgin concrete product. Accordingly, use of such fine reclaimed particles reduces the overall carbon dioxide production associated with the concrete and asphalt industries by reducing the amount of carbon dioxide-intensive cement or supplementary cementitious material required to be produced for given concrete, mortar or asphalt needs, in a carbon-dioxide-efficient manner.

The particle size/average particle size/size distribution and quantity of the reclaimed particles and/or cementitious fines that is incorporated into new concrete in substitution for aggregate or supplementary cementitious material can be varied as desired to achieve desired structural properties of the cured concrete, such as mechanical (e.g., compressive strength, flexural strength, tensile strength, bond strength, bond to reinforcement, etc.) and durability (e.g., porosity, electric resistivity, creep, shrinkage, resistance to freeze and thaw, resistance to carbonation, etc.). In certain applications, up to 80%, up to 75%, up to 70%, up to 65%, up to 60%, up to 55%, up to 50%, up to 45%, up to 40%, up to 35%, up to 30%, up to 25%, up to 20%, up to 15%, up to 10% and up to 5% of cement or supplementary cementitious material may be substituted with reclaimed particles and/or cementitious fines produced according to the present invention to obtain cement-based materials having satisfactory material properties.

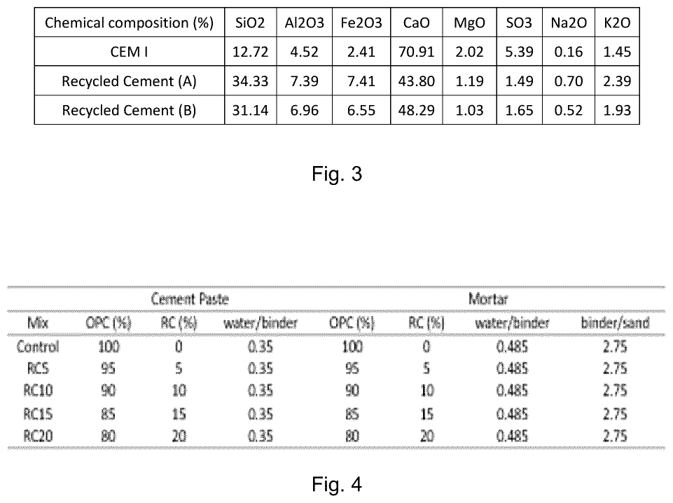

FIG. 3 shows a table of chemical compositions of exemplary recycled cements in accordance with the present invention in comparison to Portland cement. FIG. 4 shows a table of exemplary cement paste and mortar specimens prepared with Ordinary Portland Cement (OPC) Type I, incorporating varying proportions of reclaimed cementitious fine parties (RC) (percentage by weight of binder). Accordingly, specimens can be compared to a control.

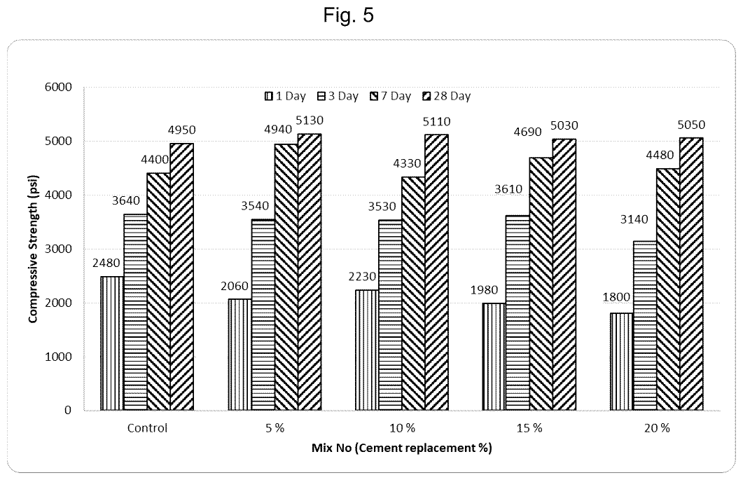

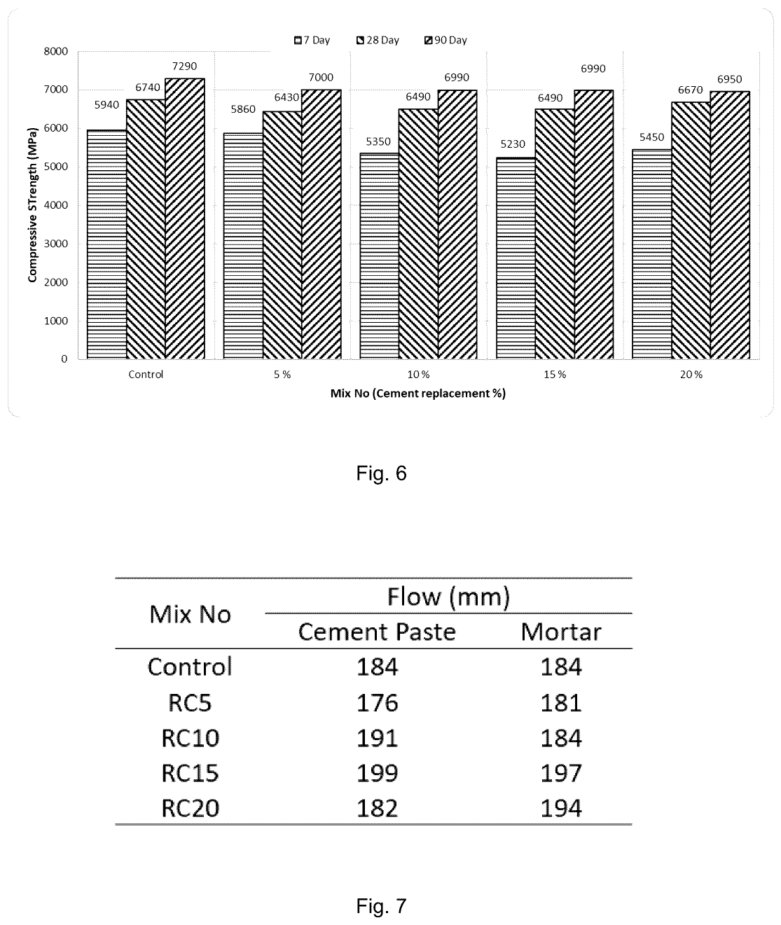

FIG. 5 shows a graph of compressive strength of cement paste specimens with different percentages of reclaimed cement in accordance with the present invention. FIG. 6 shows a graph of compressive strength of mortar specimens with difference percentages of reclaimed cement in accordance with the present invention. Collectively, the FIGS. 5 and 6 show that the substitution of reclaimed cementitious particles with fine particle size for new (virgin) dry cement powder did not result in any significant reduction in compressive strength, and in some cases it actually improved the compressive strength slightly.

FIG. 7 shows a table comparing flow measurements for the cement paste and mortar specimens shown in FIG. 4. As will be appreciated from FIG. 7, the flow test results show no significant adverse effect from replacing cement with RC in accordance with the present invention.

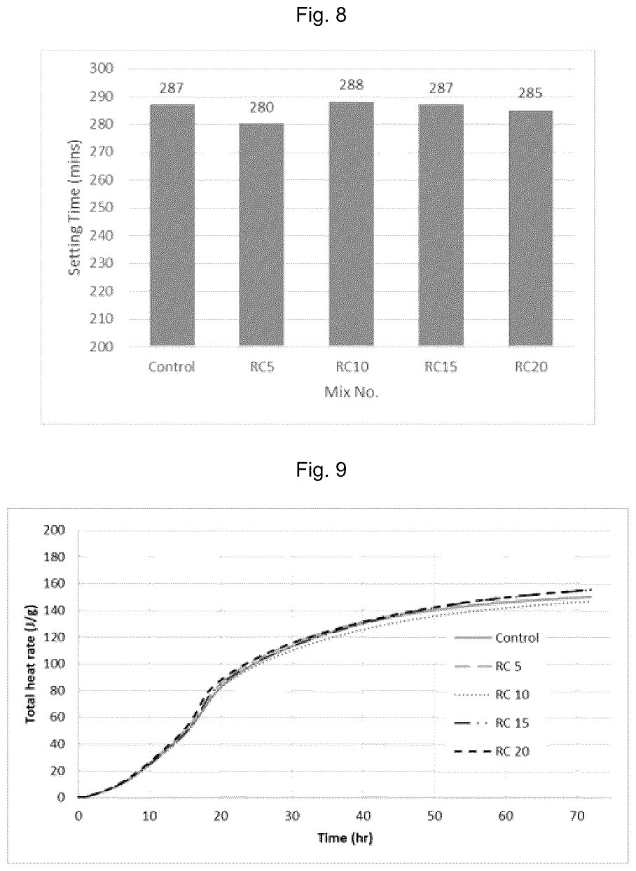

FIG. 8 shows a graph comparing setting times or the cement paste and mortar specimens shown in FIG. 4. As will be appreciated from FIG. 8, partially replacing cement with up to 20% RC has an insignificant effect on the initial setting time of cement paste, showing a difference of only a few minutes.

FIG. 9 shows a graph of total heat rate of hydration for the cement paste specimens shown in FIG. 4. As will be appreciated from FIG. 9, data from the total heat of hydration for cement paste specimens shows that replacing cement with RC lowers the total heat generated during the first 3 days of curing.

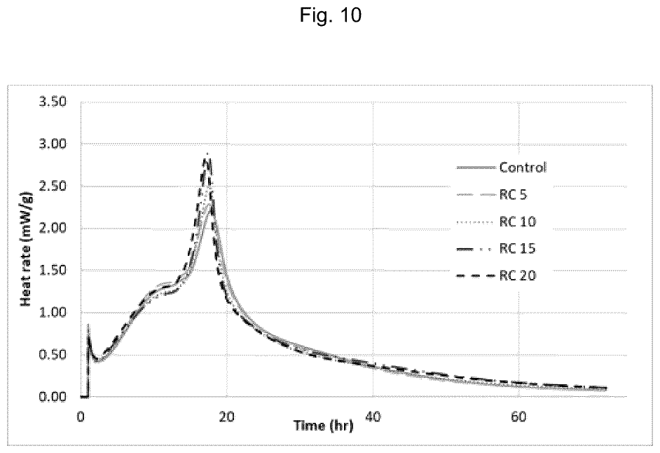

FIG. 10 shows a graph of accumulative heat of hydration for the cement paste specimens shown in FIG. 6.

Accordingly, as will be appreciated from FIGS. 6-10, there is no significant (adverse) change in various properties resulting from the use of RC in substitution for dry virgin cement powder, at least in suitable particle size and percentage ranges.

Accordingly, the present invention can be used to reduce the demand for new cement (e.g., for use in asphalt, concrete and mortar), by using instead fine reclaimed cementitious particles (e.g., including previously hydrated cement) by processing recycled cement-containing materials (e.g., concrete, mortar, etc.) to reclaim the cementitious fines. The cementitious fines are used, in accordance with the present invention, as a substitute for virgin cement material, e.g., to produce new cement-based materials, such as concrete, mortar and asphalt, that include reclaimed cementitious particles in at least partial substitution for virgin cement particles.

Cement-based materials in accordance with the present invention may be made by incorporation of one or more of reclaimed cementitious fines and/or reclaimed particles in a cement-based material mix, as described in greater detail below.

New cement paste in accordance with the present invention may be made by preparing cement paste comprising a mixture of virgin cement material and reclaimed cementitious fines in substitution for virgin dry cement powder material or supplementary cementitious materials in a cement paste mix.

New cement mortar in accordance with the present invention may be made by preparing mortar comprising a mixture of virgin cement material and reclaimed cementitious fines in substitution for virgin dry cement powder material or supplementary cementitious materials in a mortar mix.

New concrete mixes (classes from normal concrete to ultra-high-performance concrete, and including concrete mixes suitable for use in 3D-printing/additive construction processes, shotcrete (spray) processes, or any other processes involving manual, mechanized or robotic construction) in accordance with the present invention may be made by preparing concrete comprising a mixture of virgin dry cement powder material and reclaimed cementitious fines in substitution for virgin dry cement powder material or supplementary cementitious materials in a concrete mix.

New concrete mixes in accordance with the present invention may be made by preparing concrete comprising a mixture of virgin dry cement powder material and/or reclaimed cementitious fines in substitution for virgin dry cement powder material, and coarse reclaimed particles in at least partial substitution for aggregate material, in a concrete mix.

New asphalt in accordance with the present invention may be made by preparing asphalt comprising a mixture of bitumen and aggregates and coarse reclaimed particles in at least partial substitution for aggregate material, in an asphalt mix.

Cement-based structures in accordance with the present invention may be made by convention construction techniques, using the novel cement-based materials described herein.

Accordingly, the present invention is usable to provide a reduction of greenhouse gas emissions (e.g., carbon dioxide) associated with the construction industry, and a reduction of environmental impacts caused by disposal of cement-containing materials in landfills and the demand for new cement in cement-based materials and structures.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method for producing reclaimed cementitious fines for use as an alternative to virgin dry cement power, the method comprising:
obtaining cement-containing waste material;
crushing the cement-containing waste material;
gathering the crushed cement-containing waste materials, the crushed cement-containing waste materials comprising reclaimed particles derived from said cement-containing waste material; and
sorting the crushed cement-containing waste materials by particle size to obtain reclaimed cementitious fines having sizes in a desired particle size range.

2. The method of claim 1, further comprising treating the reclaimed cementitious fines to change at least one material property of the reclaimed cementitious fines.

3. The method of claim 1, wherein said treating the reclaimed cementitious fines to change at least one material property of the reclaimed cementitious fines comprises performing at least one treatment selected from a group consisting of heating, burning, adding additives to, adding fillers to, and adding pigments to the reclaimed cementitious fines.

4. The method of claim 1, wherein said obtaining cement-containing materials comprises obtaining cement-containing waste materials selected from a group consisting of recycled concrete aggregate (RCA) material, demolished concrete aggregate material, and demolished brick wall material containing cement-based mortar.

5. The method of claim 1, wherein said crushing the cement-containing waste material comprises at least one of a tumbling, an abrasion, a grinding and an impact step.

6. The method of claim 1, wherein said crushing the cement-containing waste material comprises tumbling of the cement-containing waste material in a drum along steel ball impactors to crush the cement-containing waste material.

7. The method of claim 1, wherein said crushing the cement-containing waste material comprises crushing to produce reclaimed particles comprising reclaimed cementitious fines having particle sizes falling in a range of about 0.1 microns to about 200 microns.

8. The method of claim 1, wherein said crushing the cement-containing waste material comprises crushing to produce reclaimed particles comprising reclaimed cementitious fines having particle sizes falling in a range of about 0.1 microns to about 100 microns.

9. The method of claim 1, wherein said sorting the crushed cement-containing waste materials by particle size comprises separating reclaimed cementitious fines having particle sizes falling in a range of about 0.1 microns to about 200 microns from a remainder of the reclaimed particles.

10. The method of claim 1, wherein said sorting the crushed cement-containing waste materials by particle size comprises sieving the reclaimed parties to obtain reclaimed cementitious fines having at least one of a desired particle size, an average particle size, and a particle size distribution.

11. A method for producing a cement-based mix material comprising reclaimed cementitious fines in substitution for virgin dry cement power, the method comprising:
obtaining cement-containing waste material;
crushing the cement-containing waste material;
gathering the crushed cement-containing waste materials, the crushed cement-containing waste materials comprising reclaimed particles derived from said cement-containing waste material; and
sorting the crushed cement-containing waste materials by particle size to obtain reclaimed cementitious fines having sizes in a desired particle size range; and
preparing at least one of a concrete mix, a mortar mix, a cement paste mix and an asphalt mix comprising said reclaimed cementitious fines.

12. The method of claim 1, further comprising treating the reclaimed cementitious fines to change at least one material property of the reclaimed cementitious fines.

13. The method of claim 1, wherein said treating the reclaimed cementitious fines to change at least one material property of the reclaimed cementitious fines comprises performing at least one treatment selected from a group consisting of heating, burning, adding additives to, adding fillers to, and adding pigments to the reclaimed cementitious fines.

14. The method of claim 1, wherein said obtaining cement-containing materials comprises obtaining cement-containing waste materials selected from a group consisting of recycled concrete aggregate (RCA) material, demolished concrete aggregate material, and demolished brick wall material containing cement-based mortar.

15. The method of claim 1, wherein said crushing the cement-containing waste material comprises at least one of a tumbling, an abrasion, a grinding and an impact step.

16. The method of claim 1, wherein said crushing the cement-containing waste material comprises tumbling of the cement-containing waste material in a drum along steel ball impactors to crush the cement-containing waste material.

17. The method of claim 1, wherein said crushing the cement-containing waste material comprises crushing to produce reclaimed particles comprising reclaimed cementitious fines having particle sizes falling in a range of about 0.1 microns to about 200 microns.

18. The method of claim 1, wherein said crushing the cement-containing waste material comprises crushing to produce reclaimed particles comprising reclaimed cementitious fines having particle sizes falling in a range of about 0.1 microns to about 100 microns.

19. The method of claim 1, wherein said sorting the crushed cement-containing waste materials by particle size comprises separating reclaimed cementitious fines having particle sizes falling in a range of about 0.1 microns to about 200 microns from a remainder of the reclaimed particles.

20. The method of claim 1, wherein said sorting the crushed cement-containing waste materials by particle size comprises sieving the reclaimed parties to obtain reclaimed cementitious fines having at least one of a desired particle size, an average particle size, and a particle size distribution.

21. A cement-based mix material comprising:
sand;
virgin cement;
water; and
reclaimed cementitious fines, said reclaimed cementitious fines comprising reclaimed particles derived from crushing cement-containing waste material, said reclaimed cementitious fines having at least one of a particle size, an average particle size, and a size distribution falling in a range of about 0.1 microns to about 200 microns.

22. The cement mix material of claim 21, wherein a combination of said virgin cement and said reclaimed cementitious fines is at least 5% to at least 80% reclaimed cementitious fines.

23. The cement mix material of claim 21, wherein said cement mix material is a cement paste material.

24. The cement mix material of claim 21, wherein said cement mix material is a cement mortar material.

25. The cement mix material of claim 21, wherein said cement mix material is an asphalt mix material further comprising bitumen and aggregate material.

26. The cement mix material of claim 26, wherein said cement mix material is an asphalt mix material further comprising reclaimed particles having a coarse particle size greater than 200 microns as at least a portion of said aggregate material, said reclaimed particles having the coarse particle size being derived by crushing cement-containing water material.

27. The cement mix material of claim 21, wherein said cement mix material is a cement-based concrete material.

28. The cement mix material of claim 27, wherein said cement based concrete material further comprises aggregate material.

29. The cement mix material of claim 27, wherein said cement mix material is a concrete material further comprises reclaimed particles having a coarse particle size greater than 200 microns as supplementary cementitious material, said reclaimed particles having the coarse particle size being derived by crushing cement-containing water material.
